(19) United States
(12) Patent Application Publication
(10) Pub. No.: US 2014/0116337 A1
(43) Pub. Date: May 1, 2014

(54) APPARATUS OF DEPOSITING ORGANIC MATERIAL

(71) Applicant: Samsung Display Co., Ltd., Yongin-city (KR)

(72) Inventor: Hak Min Kim, Osan-si (KR)

(73) Assignee: Samsung Display Co., Ltd., Yongin-city (KR)

(21) Appl. No.: 13/947,933

(22) Filed: Jul. 22, 2013

(30) Foreign Application Priority Data
Oct. 26, 2012 (KR) 10-2012-0119782

(51) Int. Cl. B05C 9/02

(52) U.S. Cl. CPC B05C 9/02
USPC 118/720

(57) ABSTRACT

In an aspect, an organic material deposition apparatus including a process chamber, a first transfer rail, a second transfer rail, at least one mask assembly, at least one substrate assembly, and at least one deposition source unit is provided. The first and second transfer rails may be located in the process chamber, and the second transfer rail may be located on and spaced apart from the first transfer rail.

### CROSS-REFERENCE TO RELATED APPLICATION

This application claims priority to and the benefit of Korean Patent Application No. 10-2012-0119782, filed on Oct. 26, 2012 the disclosure of which is hereby incorporated by reference in its entirety.

### BACKGROUND

1. Field

The described technology generally relates to an apparatus for depositing an organic material. More particularly, the described technology relates to an apparatus for depositing an organic material, which is capable of depositing the organic material on a substrate using an evaporation method.

2. Description of the Related Technology

An apparatus for depositing an organic material is widely used to manufacture an organic electroluminescent display device. The organic electroluminescent display device may include an anode electrode, a cathode electrode, and layers located between the anode electrode and the cathode electrode, e.g., a hole injection layer, a hole transport layer, an organic light emitting layer, an electron transport layer, and an electron injection layer. The hole injection layer, the hole transport layer, the organic light emitting layer, the electron transport layer, and the electron injection layer may be formed by depositing an organic material on a substrate.

In general, an evaporation method is typically used to deposit the organic material on the substrate. Depending on the evaporation method, a deposition source unit may be located in a chamber to heat and evaporate an organic material where the organic material evaporated by the deposition source unit is deposited on the substrate. In an evaporation method where the substrate and a mask are located inside the chamber, the mask may be deformed by the weight of the substrate and the mask. Particularly, as the size of the substrate increases, the deformation of the mask may be intensified.

### SUMMARY

The present disclosure provides an apparatus of depositing an organic material, which is capable of efficiently depositing the organic material on a substrate.

Some embodiments provide an organic material deposition apparatus includes a process chamber, a first transfer rail, a second transfer rail, at least one mask assembly, at least one substrate assembly, and at least one deposition source unit.

In some embodiments, the first and second transfer rails are located in the process chamber, and the second transfer rail is located on and spaced apart from the first transfer rail. In some embodiments, the mask assembly is coupled with and transferred along the first transfer rail, and the substrate assembly is coupled with a substrate and the second transfer rail and transferred along the second transfer rail. In some embodiments, the deposition source unit is located in the process chamber and provides the organic material to the mask assembly and the substrate assembly.

In some embodiments, the substrate assembly on which the substrate is formed may be spaced apart from the mask assembly on which the mask is formed. In some embodiments, the mask may be prevented from being deformed since weight from the substrate is not applied to the mask even though the organic material is on the substrate. Thus, the organic material may be easily deposited on a large-scale substrate by using the organic material deposition apparatus.

In some embodiments, plural deposition source units, plural mask assemblies, and plural substrate assemblies, each of which are different or the same, are located in one process chamber. In some embodiments, the organic materials may be substantially simultaneously deposited on the substrates located on the substrate assemblies. Thus, a process time required to deposit the organic materials on the substrates may be reduced, and configurations of the organic material deposition apparatus may be simplified. In some embodiments, the organic materials may be the same as each other. In some embodiments, the organic materials may be different form each other. In some embodiments, the mask assembly comprises: at least one mask; at least one mask frame coupled with an end portion of the at least one mask; and at least one mask carrier coupled with the at least one mask frame and the first transfer rail and provided with an opening formed therethrough to expose the at least one mask except for the end portion of the at least one mask, and, each substrate assembly comprises: a substrate carrier coupled with an end portion of the substrate and the second transfer rail and provided with an opening formed therethrough to expose the substrate except for the end portion of the substrate; and a chucking member on the substrate carrier to chuck the end portion of the substrate. In some embodiments, the apparatus comprises more than one deposition source unit, wherein at least two deposition source units are configured to provide different organic materials from each other. In some embodiments, each of the mask assembly and the substrate assembly is provided in the same number as the number of the deposition source units. In some embodiments, the apparatus comprises more than one mask wherein the masks correspond to the mask assemblies in a one-to-one correspondence relation, and at least one of the masks is an open mask opened corresponding to a cell area of the substrate. In some embodiments, the apparatus comprises more than one mask wherein the masks correspond to the mask assemblies in a one-to-one correspondence relation, and at least one of the masks is a pattern mask in which a mask pattern is formed corresponding to a cell area of the substrate. In some embodiments, the apparatus comprises more than one deposition source unit in the process chamber, wherein at least two deposition source units of the deposition source units provide the same organic material. In some embodiments, each of the mask assembly and the substrate assembly is provided in the same number as the number of the deposition units. In some embodiments, the apparatus comprises more than one mask wherein the masks correspond to the mask assemblies in a one-to-one correspondence relation, and at least one of the masks is an open mask opened corresponding to a cell area of the substrate. In some embodiments, the apparatus comprises more than one mask wherein the masks correspond to the mask assemblies in a one-to-one correspondence relation, and at least one of the masks is a pattern mask in which a mask pattern is formed corresponding to a cell area of the substrate.

### BRIEF DESCRIPTION OF THE DRAWINGS

The above and other advantages of the present disclosure will become readily apparent by reference to the following detailed description when considered in conjunction with the accompanying drawings wherein:

FIG. 1 is a cross-sectional view showing an organic material deposition apparatus according to an exemplary embodiment of the present disclosure;

FIG. 2 is an enlarged perspective view showing a portion inside a process chamber shown in FIG. 1;

FIG. 3A is an exploded perspective view showing a mask assembly shown in FIG. 2;

FIG. 3B is an exploded perspective view showing a substrate assembly shown in FIG. 2;

FIG. 4 is a cross-sectional view showing an organic material deposition apparatus according to another exemplary embodiment of the present disclosure;

FIG. 5 is an exploded perspective view showing a mask assembly shown in FIG. 4;

FIG. 6 is a cross-sectional view showing an organic material deposition apparatus according to another exemplary embodiment of the present disclosure; and

FIG. 7 is a cross-sectional view showing an organic material deposition apparatus according to another exemplary embodiment of the present disclosure.

### DETAILED DESCRIPTION

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the present embodiments. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present embodiments will be explained in detail with reference to the accompanying drawings.

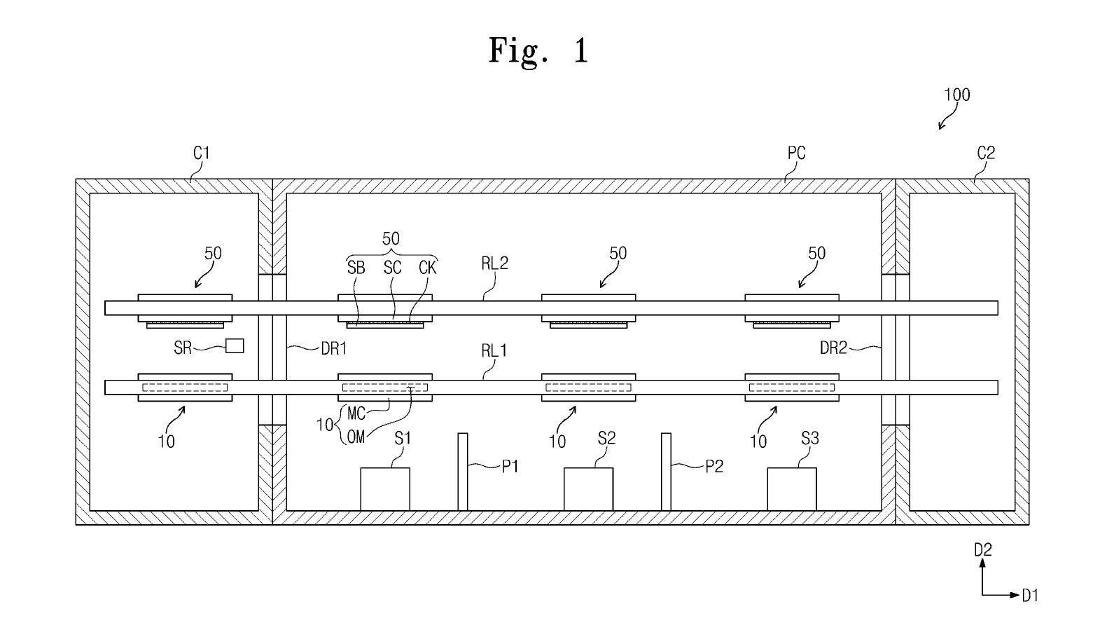

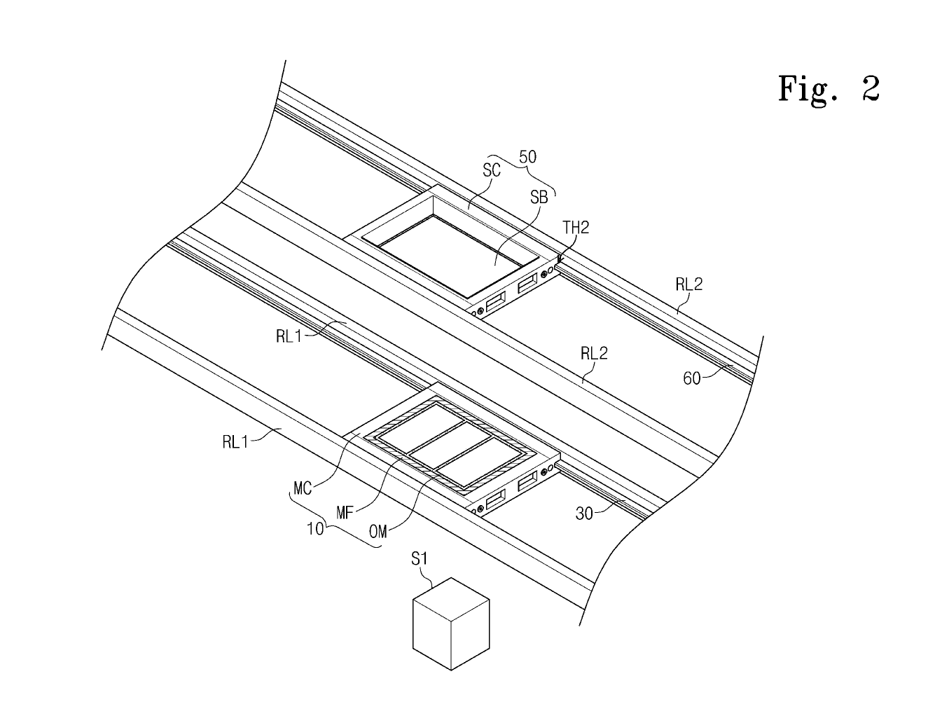

FIG. 1 is a cross-sectional view showing an organic material deposition apparatus according to an exemplary embodiment of the present disclosure and FIG. 2 is an enlarged perspective view showing a portion inside a process chamber shown in FIG. 1.

Referring to FIGS. 1 and 2, the organic material deposition apparatus 100 is used to deposit an organic material on a substrate SB. In some embodiments, the organic material deposition apparatus 100 may be used to manufacture an organic electroluminescent display device. In some embodiments, the organic material may be deposited on the substrate SB using the organic material deposition apparatus 100 to form a hole injection layer, a hole transport layer, an organic light emitting layer, an electron injection layer and an electron transport layer, which form pixels of the organic electroluminescent display device.

The organic material deposition apparatus 100 includes a process chamber PC, a first deposition source unit S1, a second deposition source unit S2, a third deposition source unit S3, a first transfer rail RL1, a second transfer rail RL2, a first auxiliary chamber C1, a second auxiliary chamber C2, a mask assembly 10, and a substrate assembly 50.

In some embodiments, the process chamber PC provides a space in which an organic material deposition process is performed to deposit organic materials from the first to third deposition source units S1, S2, and S3 on the substrate SB. In some embodiments, an evaporation method that evaporates the organic materials to be deposited on the substrate SB may be used as the organic material deposition process. In some embodiments, the process chamber PC maintains a vacuum state.

The process chamber PC includes an entrance portion DR1 formed through a side thereof and an exit portion DR2 formed through the other side thereof. In some embodiments, the mask assembly 10 and the substrate assembly 50 enter into the process chamber PC through the entrance portion DR1 and the mask assembly 10 and the substrate assembly 50 exit from the process chamber PC through the exit portion DR2 after the organic material deposition process is completed inside the process chamber PC.

In some embodiments, the first to third deposition source units S1 to S3 evaporate the organic materials and provide the evaporated organic materials to the mask assembly 10 and the substrate assembly 50. In some embodiments, the first to third deposition source units S1 to S3 are located on a bottom portion of the process chamber PC and arranged in a first direction D1 to be spaced apart from each other. In some embodiments, the evaporated organic materials from the first to third deposition source units S1 to S3 move toward the mask assembly 10 and the substrate assembly 50 along a second direction D2 substantially vertical to the first direction D1.

In addition, a first partition wall P1 and a second partition wall P2 are located on the bottom portion of the process chamber PC. The first partition wall P1 is located between the first and second deposition source units S1 and S2 and the second partition wall P2 is located between the second and third deposition source units S2 and S3.

In some embodiments, the organic materials from the first to third depositions source units S1 to S3 may be prevented from being mixed with each other while the organic materials move to the mask assembly 10 and the substrate assembly 50 due to the first and second partition walls P1 and P2.

In some embodiments, the first to third deposition source units S1 to S3 may provide different organic materials from each other. For instance, when the organic material deposition apparatus 100 is used to manufacture the organic electroluminescent display device, the first deposition source unit S1 may provide an organic material required to form the hole injection layer of the organic electroluminescent display device, the second deposition source unit S2 may provide an organic material required to form the hole transport layer of the organic electroluminescent display device, and the third deposition source unit S3 may provide an organic material required to form the organic light emitting layer of the organic electroluminescent display device.

In some embodiments, three deposition source units, i.e., the first to third deposition source units S1 to S3, are located in the process chamber PC, but the number of the deposition source units should not be limited to three. In some embodiments, the number of the deposition source units may be less or more than three.

In some embodiments, the first auxiliary chamber C1 is located adjacent to the entrance portion DR1 of the process chamber PC and the second auxiliary chamber C2 is located adjacent to the exit portion DR2 of the process chamber PC. Therefore, the inside of the first auxiliary chamber C1 is connected to the inside of the process chamber PC through the entrance portion DR1 and the inside of the second auxiliary chamber C2 is connected to the inside of the process chamber PC through the exit portion DR2.

In some embodiments, the mask assembly 10 and the substrate assembly 50 wait in the first auxiliary chamber C1 to be entered into the process chamber PC, and the mask assembly 10 and the substrate assembly 50 on which the organic material deposition process is applied wait in the second auxiliary chamber C2.

In some embodiments, the first transfer rail RL1 is located in the process chamber PC and extended in the first direction D1 to cross the inside of the process chamber PC. In some embodiments, the first transfer rail RL1 is coupled with the mask assembly 10 to guide the movement of the mask assembly 10.

In some embodiments, the second transfer rail RL2 is located on the first transfer rail RL1 in the process chamber PC and extended in the first direction D1 to be substantially parallel to the first transfer rail RL1. In some embodiments, the second transfer rail RL2 is coupled with the substrate assembly 50 to guide the movement of the substrate assembly 50.

As described above, when the first and second auxiliary chambers C1 and C2 are located at both sides of the process chamber PC, the first and second transfer rails RL1 and RL2 may be extended to the first and second auxiliary chambers C1 and C2 after passing through the entrance portion DR1 and the exit portion DR2. In some embodiments, the mask assembly 10 and the substrate assembly 50 may be sequentially transferred to the first auxiliary chamber C1, the process chamber PC, and the second auxiliary chamber C2 by the first and second transfer rails RL1 and RL2.

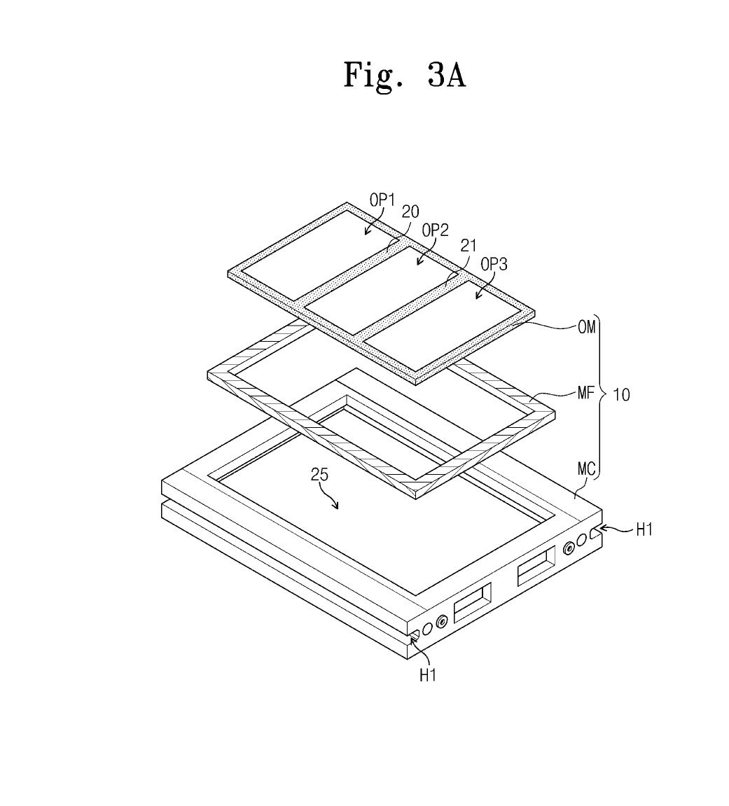

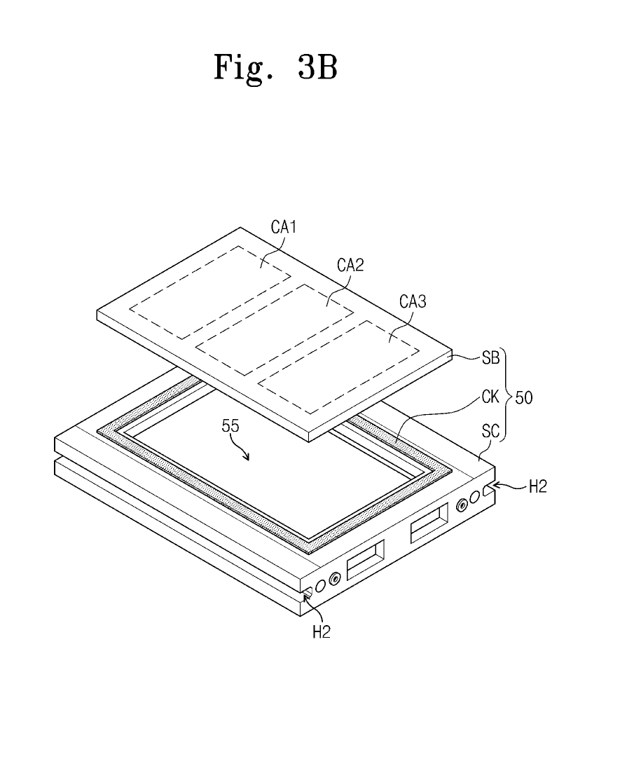

In some embodiments, the mask assembly 10 may be provided in the same number as the number of the first to third deposition source units S1 to S3. In this case, since the mask assemblies have the same structure and function, only one mask assembly will be further described in detail with reference to FIG. 3A, and detailed descriptions of the other mask assemblies will be omitted.

FIG. 3A is an exploded perspective view showing a mask assembly shown in FIG. 2.

Referring to FIGS. 1, 2, and 3A, the mask assembly 10 includes an open mask OM, a mask carrier MC, and a mask frame MF. In some embodiments, the open mask OM includes openings formed therethrough to correspond to cell areas of the substrate SB in a one-to-one correspondence and supporters connected to an end portion thereof to enhance rigidity thereof. In some embodiments, when the substrate SB includes first, second, and third cell areas CA1, CA2, and CA3 (refer to FIG. 3B), the open mask OM includes first, second, and third openings OP1, OP2, and OP3 respectively corresponding to the first, second, and third cell areas CA1, CA2, and CA3. In some embodiments, the open mask OM includes a first supporter 20 located between the first and second openings OP1 and OP2 and a second supporter 21 located between the second and third openings OP2 and OP3.

The mask frame MF has a shape surrounding the end portion of the open mask OM and is coupled with the end portion of the open mask OM. In some embodiments, the end portion of the open mask OM may be supported by the mask frame MF, and thus the rigidity of the open mask OM may be enhanced. Consequently, the open mask OM may be easily handled.

In some embodiments, the mask carrier MC may be coupled with the mask frame MF. In some embodiments, the mask carrier MC includes an opening 25 formed therethrough to correspond to the first to third openings OP1 to OP3, and the mask frame MF may be inserted into the opening 25 to be coupled with the mask carrier MC. Thus, when the mask frame MF coupled with the open mask OM is coupled with the mask carrier MC, the open mask OM is exposed through the opening 25 except for the end portion of the open mask OM.

In some embodiments, the mask carrier MC may be coupled with the first transfer rail RL1. In some embodiments, the mask carrier MC includes first grooves H1 formed at both sides thereof facing each other along the first direction D1, and first protrusions 30 of the first transfer rail RL1 are respectively inserted into the first grooves H1.

In some embodiments, the mask carrier MC may be transferred in the first direction D1 in which the first transfer rail RL1 and the first grooves H1 are formed.

In some embodiments, the mask carrier MC may be transferred along the first transfer rail RL1 using a magnetic levitation method. In some embodiments, the mask carrier MC further includes a magnetic member (not shown) located in the first grooves H1 and the first protrusions 30 include another magnetic member that generates a repulsive force in cooperation with the mask member located in the first grooves H1.

In some embodiments, the mask carrier MC may be transferred along the first transfer rail RL1 through a rectilinear motion tool, e.g., a driving roller, a driving chain, etc. For instance, in the case that the mask carrier MC is transferred by using the driving roller, transfer rollers (not shown) making contact with an upper surface of the first protrusions 30 and operated by a driver (not shown) may be located in the first grooves H1.

In some embodiments, the substrate assembly 50 may be provided in the same number as the number of the first to third deposition source units S1 to S3 and the number of the mask assemblies 10. In this case, since the substrate assemblies have the same structure and function, only one substrate assembly will be described in detail with reference to FIG. 3B, and detailed descriptions of the other substrate assemblies will be omitted.

FIG. 3B is an exploded perspective view showing a substrate assembly shown in FIG. 2.

Referring to FIGS. 1, 2, and 3B, the substrate assembly 50 includes the substrate SB, a substrate carrier SC, and a chucking member CK. In some embodiments, the substrate SB includes the first to third cell areas CA1 to CA3 respectively corresponding to the first to third openings OP1 to OP3 when the open mask OM includes the first to third openings OP1 to OP3.

In some embodiments, the substrate carrier SC is coupled with the substrate SB. In some embodiments, the substrate carrier SC includes an opening 55 formed therethrough to expose the first to third cell areas CA1 to CA3 of the substrate SB, and is coupled with an end portion of the substrate SB except for the first to third cell areas CA1 to CA3.

In some embodiments, the chucking member CK is located on the substrate carrier SC to chuck the end portion of the substrate SB. In some embodiments, the substrate SB may be prevented from being detached from the substrate carrier SC by the chucking member CK as shown in FIG. 2 although the substrate SB may be located under the substrate carrier SC to be closer to the first deposition source unit S1. In some embodiments, the chucking member CK may chuck the substrate SB in an electrostatic method or an adhesion method when the process chamber PC maintains the vacuum state.

In some embodiments, the substrate carrier SC may be coupled with the second transfer rail RL2. In some embodiments, the substrate carrier SC includes second grooves H2 formed at both sides thereof facing each other along the first direction D1, and second protrusions 60 of the second transfer rail RL2 are respectively inserted into the second grooves H2. Thus, the substrate carrier SC may be transferred in the first direction D1 in which the second transfer rail RL2 and the second grooves H2 are formed.

In some embodiments, the substrate carrier SC may be transferred along the second transfer rail RL2 using the magnetic levitation method. In some embodiments, the substrate carrier SC further includes a magnetic member (not shown) located in the second grooves H2 and the second protrusions 60 include another magnetic member that generates the repulsive force in cooperation with the mask member located in the second grooves H2.

In some embodiments, the substrate carrier SC may be transferred along the second transfer rail RL2 through the rectilinear motion tool, e.g., a driving roller, a driving chain, etc.

In some embodiments, the organic material deposition apparatus 100 further includes a sensor SR located in the first auxiliary chamber C1. In some embodiments, the sensor SR senses a first distance between the first and second transfer rails RL1 and RL2 or a second distance between the mask assembly 10 and the substrate assembly 50. Thus, the mask assembly 10 and the substrate assembly 50 may be prevented from making contact with each other using data related to the first and second distances provided from the sensor SR. Therefore, the organic material deposited on the substrate SB may be prevented from being scratched or damaged.

In some embodiments, the first to third deposition source units S1 to S3 provide different organic materials from each other, and the mask assemblies and the substrate assemblies, which correspond to each other in a one-to-one correspondence and are aligned in a pair-wise manner, are transferred between the first auxiliary chamber C1 and the second auxiliary chamber C2 after passing through the process chamber PC along the first direction D1. As a result, the organic material provided from the first deposition source unit S1, the organic material provided from the second deposition source unit S2, and the organic material provided from the third deposition source unit S3 are sequentially deposited on the substrate SB located on each substrate assembly.

In some embodiments, the different organic materials provided from the first to third deposition sources S1 to S3 may be successively deposited on the substrate SB in the process chamber PC. Therefore, the organic material deposition process, which deposits different organic materials on the substrate SB, may be easily performed, and the organic material deposition process is performed sequentially or en bloc in the process chamber PC. As a result, the configuration of the organic material deposition apparatus may be simplified.

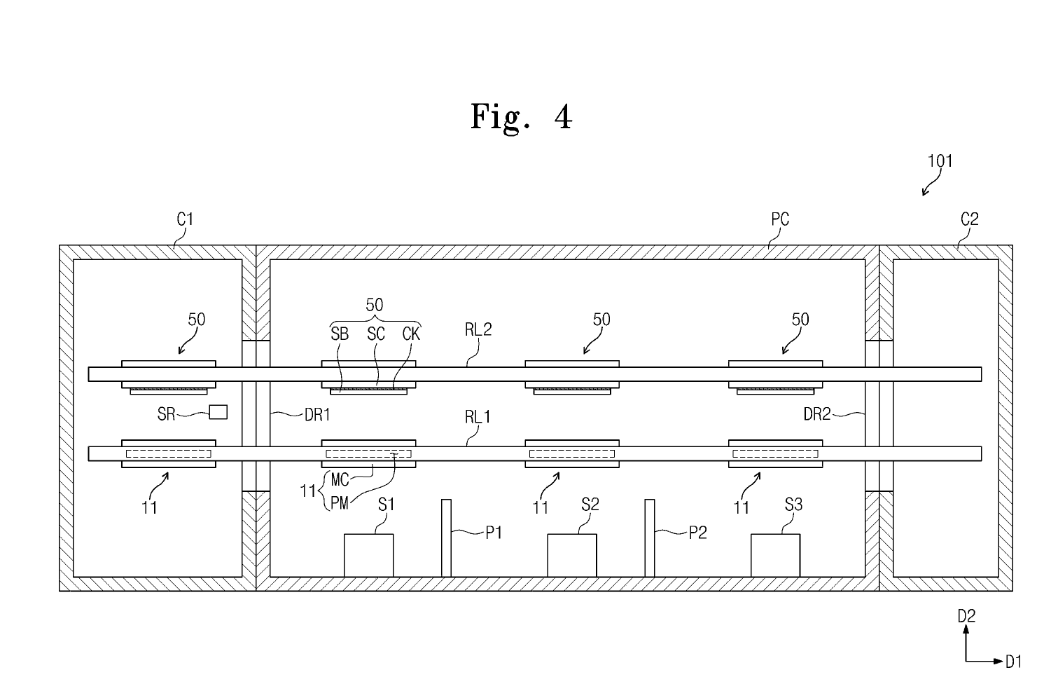

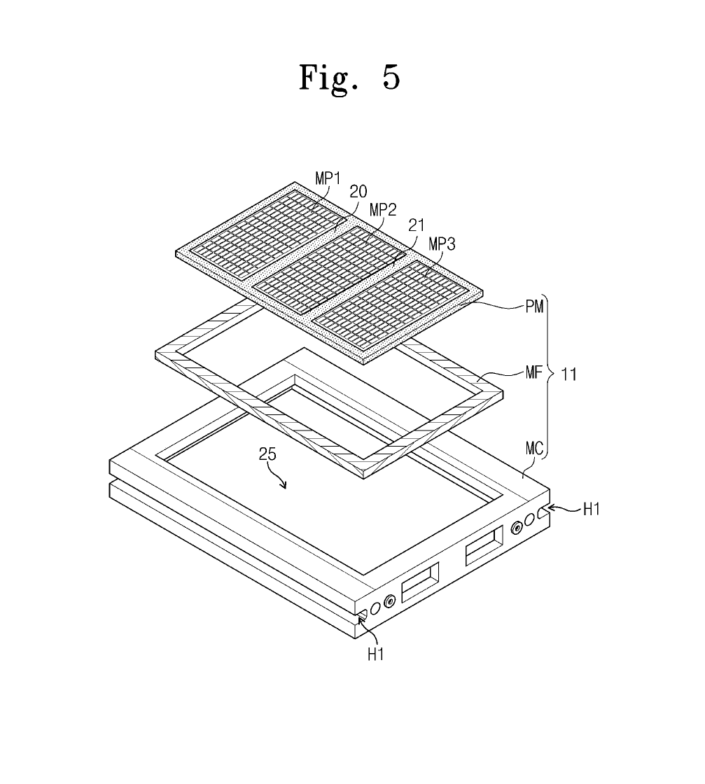

FIG. 4 is a cross-sectional view showing an organic material deposition apparatus according to another exemplary embodiment of the present disclosure and FIG. 5 is an exploded perspective view showing a mask assembly shown in FIG. 4. In FIGS. 4 and 5, the same reference numerals denote the same elements in FIGS. 1, 2, 3A, and 3B, and thus detailed descriptions of the same elements will be omitted in order to avoid redundancy.

Referring to FIGS. 4 and 5, a mask assembly 11 is included in the same number as the number of the first to third deposition source units S1 to S3 and the number of the substrate assemblies 50. Here, the mask assemblies have the same structure and function, and thus one mask assembly will be described in detail and the others will be omitted.

In some embodiments, the mask assembly 11 includes a patterning mask PM, a mask carrier MC, and a mask frame MF. That is, the mask assembly 11 includes the patterning mask PM instead of the open mask OP shown in FIG. 3A.

In some embodiments, the patterning mask PM includes first, second, and third mask patterns MP1, MP2, and MP3 corresponding to the first, second, and third cell areas CA1, CA2, and CA3 shown in FIG. 3B in a one-to-one correspondence, and each of the first, second, and third mask patterns MP1, MP2, and MP3 includes a plurality of fine openings formed therethrough. In some embodiments, the organic materials provided from the first to third deposition sources S1 to S3 may be deposited on the substrate SB through the first to third mask patterns MP1 to MP3, so that the organic materials may be patterned by the first to third mask patterns MP1 to MP3 while being deposited on the substrate SB.

In some embodiments, the patterning mask PM may be a metal mask with the first to third mask patterns MP1 to MP3, e.g., a fine metal mask.

In some embodiments, the first to third deposition source units S1 to S3 provide different organic materials from each other, and the mask assemblies and the substrate assemblies, which correspond to each other in a one-to-one correspondence and are aligned in a pair-wise manner, are transferred between the first auxiliary chamber C1 and the second auxiliary chamber C2 after passing through the process chamber PC along the first direction D1. In some embodiments, a first organic material provided from the first deposition source unit S1, a second organic material provided from the second deposition source unit S2, and a third organic material provided from the third deposition source unit S3 may be sequentially deposited on the substrate SB located on each substrate assembly. In some embodiments, the first to third organic materials may be patterned by the patterning mask PM located on the mask assembly 11 while being deposited on the substrate SB.

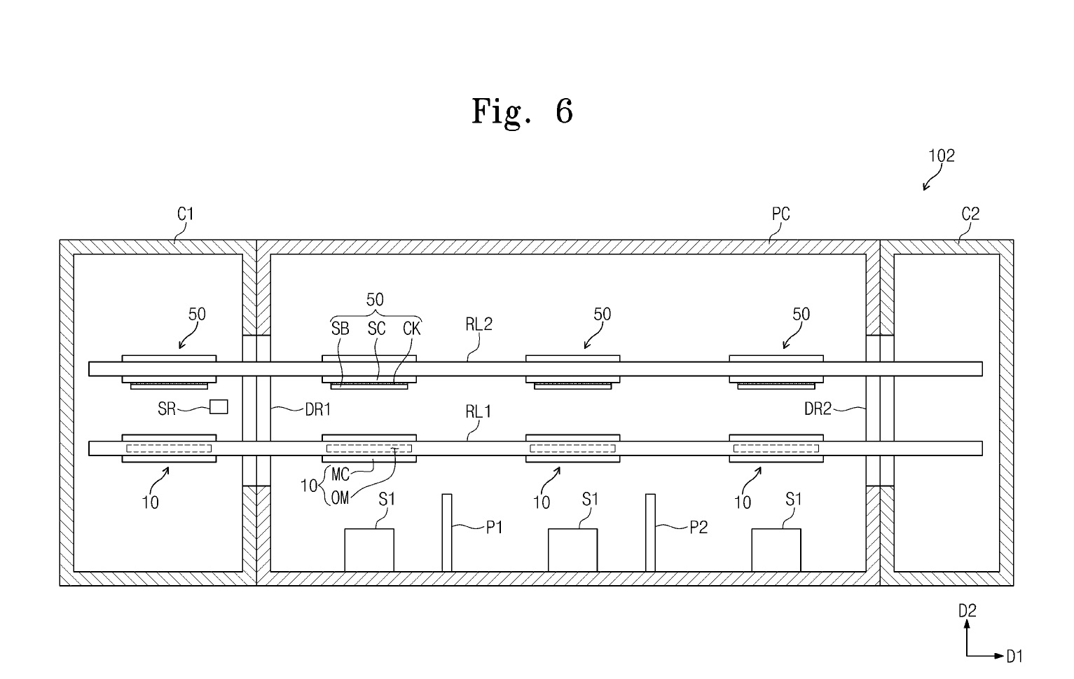

FIG. 6 is a cross-sectional view showing an organic material deposition apparatus according to another exemplary embodiment of the present disclosure. In FIG. 6, the same reference numerals denote the same elements in FIGS. 1, 2, 3A, and 3B, and thus detailed descriptions of the same elements will be omitted.

Referring to FIG. 6, different from the organic material deposition apparatus 100 shown in FIG. 1, the organic material deposition apparatus 102 includes deposition source units that provide the same organic materials. In the embodiment shown in FIG. 6, the organic material deposition apparatus 102 includes three first deposition source units S1 sequentially arranged in the first direction D1.

Depending on the configuration of the organic material deposition apparatus 102, three mask assemblies 10 correspond to three substrate assemblies 50 in a one-to-one correspondence and are aligned in a pair-wise manner, and then enter into the process chamber PC. In some embodiments, the organic material may be deposited on the substrate SB located on each of the three substrate assemblies 50 at once where each of the three first deposition source units Si provides the organic material.

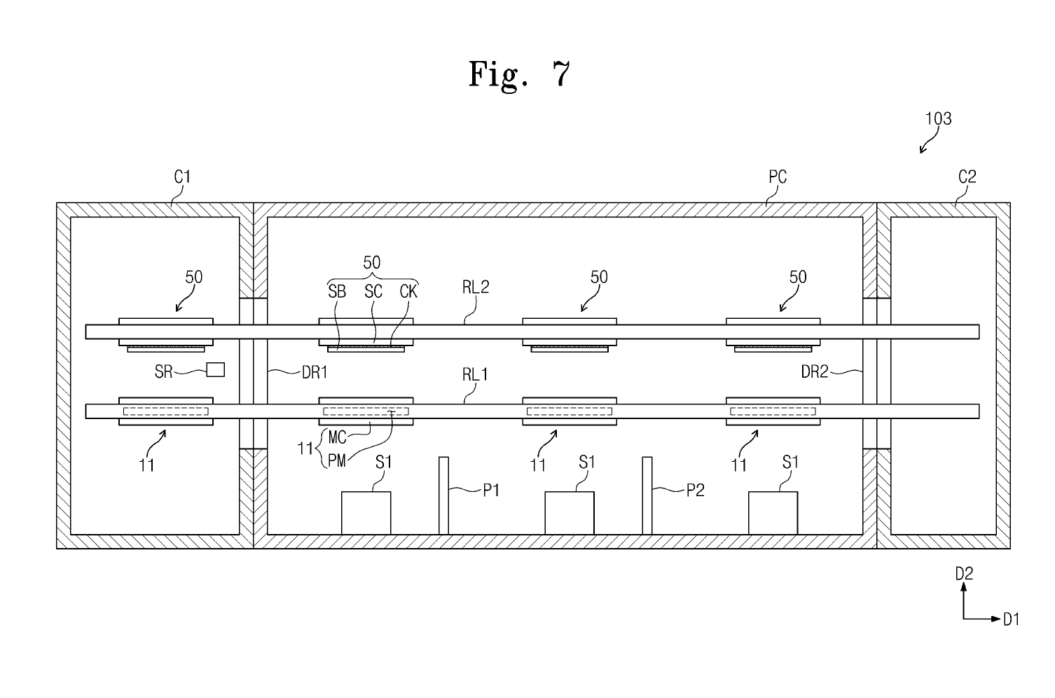

FIG. 7 is a cross-sectional view showing an organic material deposition apparatus according to another exemplary embodiment of the present disclosure. In FIG. 7, the same reference numerals denote the same elements in FIGS. 1, 2, 3A, and 3B, and thus detailed descriptions of the same elements will be omitted.

Referring to FIG. 7, different from the organic material deposition apparatus 101 shown in FIG. 4, the organic material deposition apparatus 103 includes deposition source units that provide the same organic materials. In the embodiment shown in FIG. 7, the organic material deposition apparatus 103 includes three first deposition source units S1 sequentially arranged in the first direction D1.

Depending on the configuration of the organic material deposition apparatus 103, three mask assemblies 11 correspond to three substrate assemblies 50 in a one-to-one correspondence and are aligned in a pair-wise manner, and then enter into the process chamber PC. In some embodiments, the organic material may be deposited on the substrate SB located on each of the three substrate assemblies 50 at once where each of the three first deposition source units S1 provides the organic material. In some embodiments, the organic material may be patterned by the patterning mask PM located on each of the three mask assemblies 11 while the organic material is deposited on the substrate SB.

Although the exemplary embodiments of the present embodiments have been described, it is understood that the present embodiments should not be limited to these exemplary embodiments but various changes and modifications can be made by one ordinary skilled in the art within the spirit and scope of the present embodiments as hereinafter claimed.

What is claimed is:

1. An apparatus of depositing an organic material on a substrate, comprising:
a process chamber;
a first transfer rail located in the process chamber;
a second transfer rail located on the first transfer rail in the process chamber and spaced apart from the first transfer rail;
at least one mask assembly coupled with the first transfer rail and transferred along the first transfer rail;
at least one substrate assembly coupled with the substrate and the second transfer rail and transferred along the second transfer rail; and
at least one deposition source unit located in the process chamber to provide the organic material to the mask assembly and the substrate assembly.

2. The apparatus of claim 1, wherein the first transfer rail and the second transfer rail are extended in a same direction and substantially in parallel to each other.

3. The apparatus of claim 2, wherein the mask assembly comprises:
at least one mask;
at least one mask frame coupled with an end portion of the at least one mask; and
at least one mask carrier coupled with the at least one mask frame and the first transfer rail and provided with an opening formed therethrough to expose the at least one mask except for the end portion of the at least one mask, and,
each substrate assembly comprises:
a substrate carrier coupled with an end portion of the substrate and the second transfer rail and provided with an opening formed therethrough to expose the substrate except for the end portion of the substrate; and
a chucking member located on the substrate carrier to chuck the end portion of the substrate.

4. The apparatus of claim 3, comprising more than one deposition source unit, wherein at least two deposition source units are configured to provide different organic materials from each other.

5. The apparatus of claim 4, wherein each of the mask assembly and the substrate assembly is provided in the same number as the number of the deposition source units.

6. The apparatus of claim 5, comprising more than one mask wherein the masks correspond to the mask assemblies in a one-to-one correspondence relation, and at least one of the masks is an open mask opened corresponding to a cell area of the substrate.

7. The apparatus of claim 5, comprising more than one mask wherein the masks correspond to the mask assemblies in a one-to-one correspondence relation, and at least one of the masks is a pattern mask in which a mask pattern is formed corresponding to a cell area of the substrate.

8. The apparatus of claim 3, comprising more than one deposition source unit in the process chamber, wherein at least two deposition source units of the deposition source units provide the same organic material.

9. The apparatus of claim 8, wherein each of the mask assembly and the substrate assembly is provided in the same number as the number of the deposition units.

10. The apparatus of claim 9, comprising more than one mask wherein the masks correspond to the mask assemblies in a one-to-one correspondence relation, and at least one of the masks is an open mask opened corresponding to a cell area of the substrate.

11. The apparatus of claim 9, comprising more than one mask wherein the masks correspond to the mask assemblies in a one-to-one correspondence relation, and at least one of the masks is a pattern mask in which a mask pattern is formed corresponding to a cell area of the substrate.

12. The apparatus of claim 3, wherein the first and second transfer rails are extended in a first direction, the mask carrier comprises a first groove formed in the first direction and coupled with the first transfer rail, and the substrate carrier comprises a second groove formed in the first direction and coupled with the second transfer rail.

13. The apparatus of claim 12, wherein the mask assembly is transferred along the first transfer rail using a magnetic levitation method and the substrate assembly is transferred along the second transfer rail using the magnetic levitation method.

14. The apparatus of claim 1, further comprising a sensor to sense at least one of a distance between the first transfer rail and the second transfer rail and a distance between the mask assembly and the substrate assembly.

15. The apparatus of claim 1, further comprising:
a first auxiliary chamber located adjacent to an entrance portion of the process chamber; and
a second auxiliary chamber located adjacent to an exit portion of the process chamber, wherein the first auxiliary chamber accommodates the mask assembly and the substrate assembly to be entered into the process chamber and the second auxiliary chamber accommodates the mask assembly and the substrate assembly, on which the organic material is deposited.

16. The apparatus of claim 15, wherein each of the first and second transfer rails is extended to the first and second auxiliary chambers after respectively passing through the entrance portion and the exit portion.
